(19) United States
(12) Patent Application Publication
(10) Pub. No.: US 2012/0135890 A1
(43) Pub. Date: May 31, 2012

(54) BIOMOLECULE ARRAY AND METHOD OF FABRICATING BIOMOLECULE ARRAY CHIP USING THE SAME

(75) Inventor: Dong-Ho SHIN, Daejeon (KR)

(73) Assignee: Electronics and Telecommunications Research Institute, Daejeon (KR)

(21) Appl. No.: 13/305,393

(22) Filed: Nov. 28, 2011

(30) Foreign Application Priority Data
Nov. 29, 2010 (KR) 10-2010-0120011

(51) Int. Cl. C40B 40/04; C40B 40/10; C40B 50/00; C40B 40/06

(52) U.S. Cl. 506/16; 506/15; 506/18; 506/23

(57) ABSTRACT

Disclosed are a biomolecule array and a method of fabricating a biomolecule array chip using the same. The present disclosure provides a simple method of fabricating a biomolecule array chip by coupling a pillar array with a well array The pillar array is provided with pillars protruded from a surface of a substrate, having a predetermined size and being arranged at a predetermined interval and is configured to apply biomolecules to a top surface of a pillar and the well array is configured so that each pillar formed in the pillar array is inserted into each well of the well array corresponding one-to-one after the biomolecule solutions are injected into each well.

### CROSS-REFERENCE TO RELATED APPLICATIONS

This application is based on and claims priority from Korean Patent Application No. 10-2010-0120011, filed on Nov. 29, 2010, with the Korean Intellectual Property Office, The present disclosure of which is incorporated herein in its entirety by reference.

### TECHNICAL FIELD

The present disclosure relates to an apparatus of fabricating a biomolecule array and a method of fabricating a biomolecule array chip using the same. More particularly, the present disclosure relates to a technology of selectively applying biomolecules to surfaces of pillars by fabricating a substrate formed with pillar arrays and a substrate formed with well arrays corresponding thereto so as to bring a biomolecule solution filled in each well disposed in the well arrays into contact with only each pillar surface of the pillar arrays.

### BACKGROUND

In the related art of fabricating a biomolecule array, there are a print micro array technology, an in situ micro array technology and a high-density bead array technology, etc.

First, the in situ technology is to fabricate the biomolecule array using a photochemical synthesis scheme using a photomask, which has been widely used to produce a high-density gene chip, such as gene expression analysis, gene copy number variation, comparative genomic sequencing, or the like. However, the related art of fabricating the biomolecule array using the photochemical synthesis scheme using the photomask may increase costs of a reagent consumed to perform the photochemical synthesis and re-design the photomask every time the configuration of the chip to be fabricated, for example, contents, a probe arrangement on the array, or the like, are changed, such that other additional costs are consumed to fabricate the photomask. Further, when a plurality of photomasks are used, a considerable amount of costs and time may be consumed.

Second, the high-density bead array technology applies biomolecules to a bead having a micro size and forming several small pools at a predetermined interval to seat the bead applied with the biomolecules in the small pools, which has been used to produce high-density biomolecule chips like the in situ technology. The related art of forming the high-density bead array needs a separate decoding process of confirming positions of contents. During this process, it is highly likely to cause errors in final experiment results.

Finally, the print microarray technology, which has been widely used to fabricate the corresponding biomolecule array from low density to middle density, fabricates an array using a pin array of which the tip is sharp, like stamping a seal on a solid support. This technology may simply fabricate the biomolecule array at lower cost, as compared with the above-mentioned technologies. However, the array fabricated by using the related art of fabricating the biomolecule array using the pin array has an irregular spot shape, which may remarkably degrade the reliability of experiment results as compared to other technologies.

### SUMMARY

The present disclosure has been made in an effort to provide a method of selectively applying biomolecules to surfaces of pillars by fabricating a substrate formed with pillar arrays and a substrate formed with well arrays corresponding thereto so as to bring a biomolecule solution filled in each well disposed in the well arrays into contact with only a top surface of each pillar of the pillar arrays.

An exemplary embodiment of the present disclosure provides a biomolecule array, including: a substrate; and a plurality of pillars formed on the substrate to be spaced apart from one another by a predetermined distance, wherein the biomolecules are applied to top surfaces of the plurality of pillars.

Another exemplary embodiment of the present disclosure provides a method of fabricating a biomolecule array chip using a pillar array and a well array, including: forming the pillar array including a plurality of pillars formed to be spaced apart from one another by a predetermined distance; forming the well array including a plurality of wells into which the plurality of pillars of the pillar array are inserted; injecting a biomolecule solution into each well of the well array; coupling the pillar array with the well array; and separating the pillar array from the well array.

As set forth above, the exemplary embodiment of the present disclosure can apply the biomolecules to only the top ends of the pillars protruded from the biomolecule arrays. In this case, the process of fabricating the biomolecule array is simple and the micro biomolecule array chip having spots with a uniform shape and biomolecule density can be easily fabricated at low costs.

Further, the exemplary embodiment of the present disclosure can fabricate the gene and protein chip having the spots for diagnosis of about 50 to 100 and minimize the experimental errors that occur due to non-uniformity of the spots as compared with the technology using the print technology of the related art.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a pillar array for forming a biomolecule array according to an exemplary embodiment of the present disclosure.

FIGS. 2A and 2B are perspective views for explaining a method of fabricating a biomolecule array according to an exemplary embodiment of the present disclosure.

FIGS. 3A to 3C are cross-sectional views for explaining a method of coupling a pillar array with a well array.

### DETAILED DESCRIPTION

In the following detailed description, reference is made to the accompanying drawing, which form a part hereof The illustrative embodiments described in the detailed description, drawing, and claims are not meant to be limiting. Other embodiments may be utilized, and other changes may be made, without departing from the spirit or scope of the subject matter presented here.

Hereinafter, exemplary embodiments of the present disclosure will be described in detail with reference to the accompanying drawings.

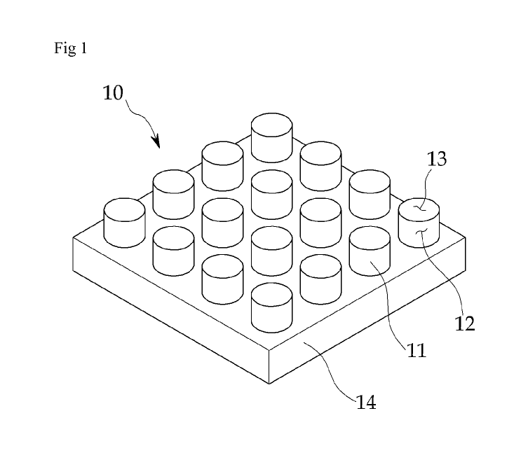

FIG. 1 is a perspective view showing a configuration of a pillar array for forming a biomolecule array according to an exemplary embodiment of the present disclosure.

A pillar array 10 includes a substrate 14 under the pillar and a plurality of pillars 11 formed on substrate 14. Plurality of pillars 11 are protruded from a surface of substrate 14 and each pillar 11 may be spaced apart from one another by a predetermined distance and may have a cylinder shape having a predetermined size. Pillar 11 may have other pillar shapes in addition to a cylinder.

A top surface 13 of pillar 11 serves as a surface to which biomolecules are applied later. In order to apply the biomolecules to only top surface 13 of pillar 11, top surface 13 and side 12 of pillar 11 are subjected to different surface treatments.

Side 12 of pillar 11 may be subjected to hydrophobic treatment so as not to contact the biomolecules. The above-mentioned hydrophobic treatment may use any one of plasma treatment using gas, deposition treatment, and wet treatment. For example, in order to perform the hydrophobic treatment, the plasma treatment using gas including at least any one of NH₃, NF₃, and F₂ is performed or any one of Si₃N₄ and SiF₄ is deposited on side 12 of pillar 11, or the wet treatment using electroplating or electroless plating may be performed.

In order to permanently fix the biomolecules to top surface 13 of pillar 11, the separate surface treatment such as hydrophilic treatment, or the like, may be performed. For example, top surface 13 of pillar 11 may be hydrophilic by performing the plasma treatment using gas including at least any one of O₂, H₂O, Ar, and He or surface reforming through a chemical method.

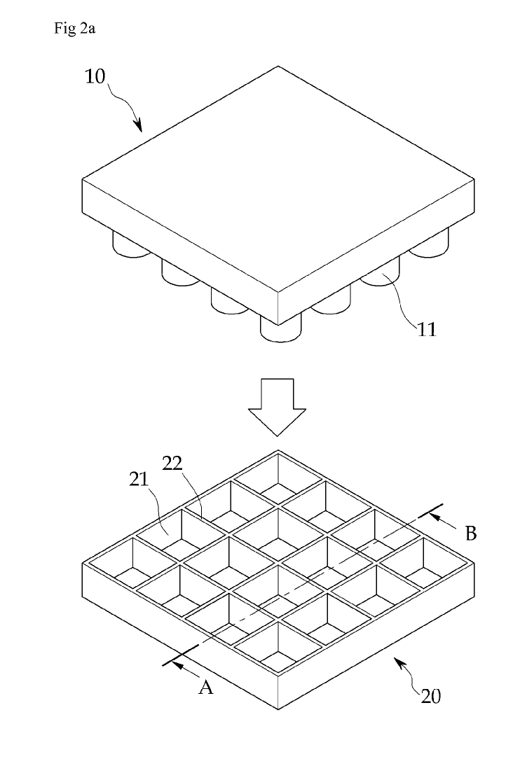

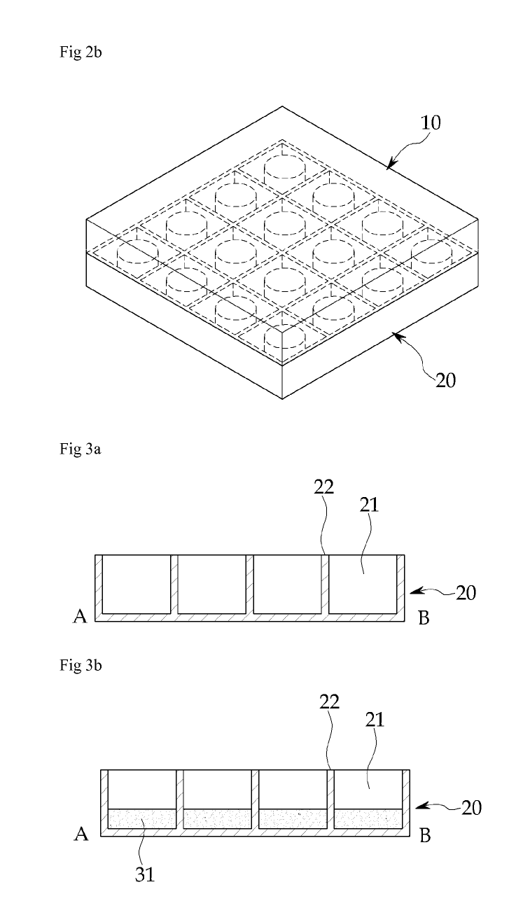

FIGS. 2A and 2B are perspective views for explaining a method of fabricating a biomolecule array according to an exemplary embodiment of the present disclosure. FIG. 2A shows a shape before pillar array 10 is coupled with well array 20 corresponding thereto and FIG. 2B shows a shape after pillar array 10 is coupled with well array 20 corresponding to thereto.

Referring to FIG. 2A, pillar array 10 shown in FIG. 1 approaches well array 20 by turning-over pillar 11 so as to be toward well array 20. Well array 20 includes a plurality of wells 21 formed on the substrate. Plurality of wells 21 is configured to include plurality of pillars 11 formed in pillar array 10 without being spaced apart from one another. Plurality of wells 21 correspond to plurality of pillars 11 one-to-one, such that the number of wells 21 may equal the number of pillars 11. Plurality of wells 21 may contain the biomolecule solution and a shielding wall 22 is formed between respective wells 21 so as not to move the solution between respective wells 21.

Each well 21 may be injected and filled with the solution including the biomolecules to be applied to top surfaces 13 of each pillar 11 of pillar array 10. The biomolecules may be nucleic acid or protein. For example, the nucleic acid may be selected from a group consisting of DNA, RNA, PNA, LNA, and a mixture thereof and the protein may be selected from a group consisting of enzyme, substrate, antigen, antibody, ligand, aptamer, and receptor.

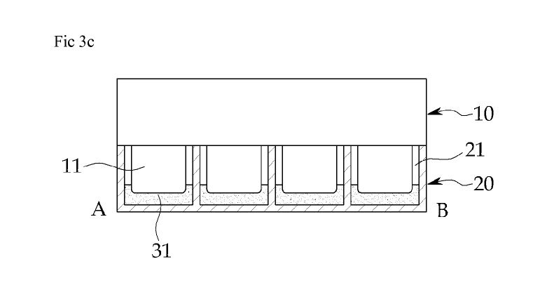

Referring to FIG. 2B, pillar array 10 is turned-over as shown in FIG. 2A to be coupled with well array 20, such that each pillar 11 of pillar array 10 enters each well 21 of well array 20. A process of coupling pillar array 10 with well array 20 will be hereinafter described with reference to FIGS. 3A to 3C.

FIGS. 3A to 3C are cross-sectional views for explaining a method of coupling a pillar array with a well array. A and B shown in FIG. 3A represent A and B for representing one direction in which a section of well array 20 is cut.

Well array 20 of FIG. 3A shows a shape before pillar array 10 is coupled with well array 20 and shielding wall 22 preventing the solution from moving is formed between respective wells 21 of well array 20 and each well 21 is empty.

Well array 20 of FIG. 3B shows a shape before pillar array 10 is coupled with well array 20 and shows a shape in which each well 21 of well array 20 is filled with biomolecule solution 31. A height of biomolecule solution 31 filled in each well 21 may be appropriately controlled so that a desired amount of biomolecules may be applied to top surfaces 13 of each pillar 11 of pillar array 10. Since each well 21 is separated from one another, different biomolecule solutions 31 may be filled in each well 21, such that different biomolecule may be applied to top surface 13 of each pillar 11 of pillar array 10.

FIG. 3C shows a shape in which pillar array 10 is coupled with well array 20. As shown in FIG. 3C, the height of biomolecule solution 31 in each well 21 may be appropriately controlled so that a desired amount of biomolecule may be applied to top surfaces 13 of each pillar 11 of pillar array 10. Alternatively, an insertion depth of pillar array 10 in well 21 may be controlled at the time of coupling pillar array 10 with well array 20 so that the desired amount of biomolecule may be applied to top surfaces 13 of each pillar 11 of pillar array 10.

Biomolecule solution 31 is applied by contacting top surfaces 13 of each pillar 11 of pillar array 10 due to the coupling of pillar array 10 with well array 20. The coupling of pillar array 10 with well array 20 is made while sufficient reaction may be generated between biomolecule solution 31 and top surfaces 13 of each pillar 11. In this case, the biomolecules may be permanently fixed to top surfaces 13 of each pillar 11.

After the sufficient reaction is generated between biomolecule solution 31 and top surfaces 13 of each pillar 11, pillar array 10 is separated from well array 20 and pillar array 10 is subjected to predetermined washing treatment. The biomolecules are permanently fixed to top surfaces 13 of each pillar 11 of pillar array 10 on substrate 14. Pillar array 10 fabricated as described above may be used as the biomolecule array chip.

When the biomolecule array chip is fabricated by the method of fabricating a biomolecule array chip, the biomolecule array having the predetermined size and the uniform density and the biomolecule array chip may be simply fabricated by applying the biomolecules to only the top surface of the projected pillar of the pillar array.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A biomolecule array, comprising:
a substrate; and
a plurality of pillars formed on the substrate to be spaced apart from one another by a predetermined distance;
wherein the biomolecules are applied to top surfaces of the plurality of pillars.

2. The biomolecule array of claim 1, wherein sides of the plurality of pillars are subjected to hydrophobic treatment and the top surfaces of the plurality of pillars are subjected to surface treatment so as to fix the biomolecules.

3. The biomolecule array of claim 2, wherein the top surfaces of the plurality of pillars are subjected to hydrophilic treatment.

4. The biomolecule array of claim 1, wherein the biomolecule is any one of DNA, RNA, PNA, enzyme, substrate, antigen, antibody, ligand, and aptamer.

5. The biomolecule array of claim 1, wherein the biomolecules applied to the top surfaces of the plurality of pillars are different from one another.

6. A method of fabricating a biomolecule array chip using a pillar array and a well array, comprising:
forming the pillar array including a plurality of pillars formed to be spaced apart from one another by a predetermined distance;
forming the well array including a plurality of wells into which the plurality of pillars of the pillar array can be inserted;
injecting a biomolecule solution into each well of the well array;
coupling the pillar array with the well array; and
separating the pillar array from the well array.

7. The method of claim 6, wherein the coupling of the pillar array with the well array includes controlling an insertion depth of the pillar array so as to bring the biomolecule solution into contact with only top surfaces of the plurality of pillars of the pillar array.

8. The method of claim 6, wherein the injecting of the biomolecule solution into each well of the well array includes controlling a height of the biomolecule solution in the well so as to bring the biomolecule solution into contact with only top surfaces of the plurality of pillars of the pillar array.

9. The method of claim 6, further comprising, after the separating of the pillar array from the well array, washing the pillar array to which the biomolecule solution is applied.

10. The method of claim 6, wherein the pillar array is formed on the substrate and the well array is formed in the substrate.

11. The method of claim 6, wherein the injecting of the biomolecule solutions to each well of the well array includes injecting different biomolecule solution into each well.

12. The method of claim 6, wherein the forming of the pillar array includes performing hydrophobic treatment on sides of the plurality of pillars and hydrophilic treatment on the top surfaces of the plurality of pillars.

13. The method of claim 6, wherein the coupling of the pillar array with the well array includes permanently fixing biomolecules to the top surfaces of the plurality of pillars of the pillar array.

14. The method of claim 6, wherein the number of pillars of the pillar array is equal to the number of wells of the well array.
